(19) United States
(12) Patent Application Publication
(10) Pub. No.: US 2025/0043397 A1
(43) Pub. Date: Feb. 6, 2025

(54) METAL MATRIX COMPOSITE MATERIAL FOR HOROLOGICAL PART

(71) Applicant: ROLEX SA, Geneva (CH)

(72) Inventor: Hossein Meidani, Geneva (CH)

(73) Assignee: ROLEX SA, Geneva (CH)

(21) Appl. No.: 18/717,499

(22) PCT Filed: Dec. 14, 2022
(86) PCT No.: PCT/EP2022/085817

§ 371 Date: Jun. 7, 2024

(30) Foreign Application Priority Data
Dec. 15, 2021 (EP) 21214892.8

(51) Int. Cl. C22C 32/00; A44C 27/00; C22C 1/04; C22C 1/059

(52) U.S. Cl. CPC C22C 32/0021; A44C 27/003; C22C 1/0466; C22C 1/059

(57) ABSTRACT

The metal matrix composite material for a horological component comprises a metal alloy based on gold, with at least 75% by weight of gold, or based on platinum, with at least 95% by weight of platinum, or based on palladium, with at least 95% by weight of palladium, the composite material further including between 0.1% and 2% by weight, or even between 0.5% and 2% by weight, or even between 0.5% and 1.5% by weight, or even between 0.5% and 1.25% by weight, or even between 0.5% and 1% by weight, of at least one hardening element, and a reinforcing material, in a proportion by mass of between 1% and 10%, or even between 1% and 5%, the reinforcing material including ceramic particles.

### INTRODUCTION

The invention relates to a material comprising a metal alloy, particularly suitable for forming all or part of a horological component, in particular for a component of a horological item such as a component of the external part of a watch. It also relates to a horological component, a timepiece, an item of jewelry or of fine jewelry per se comprising such a material, such as a wristwatch. The invention also relates to a method for the manufacture of such a material.

### PRIOR ART

It is known to use metal alloys to form horological components, in particular components of the external part of a watch, with the aim of meeting the many demands placed on such components, particularly in order to obtain, on the one hand, a desired color and on the other hand, a high mechanical strength.

Certain alloys, such as the alloy Au75Ag25, have the advantage of an attractive color which would therefore meet demands regarding the color of a horological component. However, such an alloy has a low hardness, of less than 40 HV, which prevents it from being used to manufacture a horological component, despite the importance of its color. In other words, the demands as regards the hardness of a horological component deprive the design expert involved in the manufacture of a horological component of the possibility of obtaining certain interesting colors that certain alloys could offer.

Apart from the two demands relating to color and hardness, the material used for the manufacture of a horological component must satisfy other requirements, including a satisfactory stability to modification of its color over time despite external stresses, for example the effect of mildly aggressive aqueous media such as faucet water, seawater, swimming pool water, salt water or indeed soapy water, and a robustness allowing it to maintain its mechanical properties over time.

Thus, one objective of the invention is to propose a material for a horological, jewelry or fine jewelry component, which has a desired color as well as a satisfactory hardness.

Another objective of the invention is to propose a material which is resistant to a modification to its color and/or its mechanical properties over time.

Another objective of the invention is to propose a method for the manufacture of such a material, which is sufficiently simple and dependable to expect good repeatability, in order to obtain a predefined color which is identical for each cycle of the manufacture.

### BRIEF DESCRIPTION OF THE INVENTION

To this end, the invention concerns a metal matrix composite material for a horological component, characterized in that it is constituted by:
a metal alloy
based on gold, the composite material comprising at least 75% by weight of gold, or
based on platinum, the composite material comprising at least 95% by weight of platinum, or
based on palladium, the composite material comprising at least 95% by weight of palladium, the composite material further comprising between 0.1% and 2% by weight of at least one hardening element, or even between 0.5% and 2% by weight, or even between 0.5% and 1.5% by weight, or even between 0.5% and 1.25% by weight, or even between 0.5% and 1% by weight of at least one hardening element; and
a reinforcement material, in a proportion by weight comprised between 1% and 10%, or even comprised between 1% and 5%, comprising ceramic particles.

The invention also pertains to a method for the manufacture of a metal matrix composite material for a horological component, characterized in that it comprises the following steps:
preparation of a metal alloy
based on gold, so as to comprise at least 75% by weight of gold in the composite material, or
based on platinum, so as to comprise at least 95% by weight of platinum in the composite material, or
based on palladium, so as to comprise at least 95% by weight of palladium in the composite material, the metal alloy further comprising a hardening element such that the composite material comprises between 0.1% and 2% by weight of at least one hardening element, or even between 0.5% and 2% by weight, or even between 0.5% and 1.5% by weight, or even between 0.5% and 1.25% by weight, or even between 0.5% and 1% by weight of at least one hardening element;
production of a metal powder from said metal alloy;
mixing of said metal powder with a reinforcing powder comprising ceramic particles, this reinforcing powder representing a proportion by weight comprised between 1% and 10%, or even comprised between 1% and 5%, in order to obtain a powdered composite material;

densification of the powdered composite material.

The invention is precisely defined in the claims.

### BRIEF DESCRIPTION OF THE FIGURES

These objectives, features and advantages of the present invention will be described in more detail in the description below of a particular embodiment given by way of non-limiting example with reference to the accompanying figures, in which:

FIG. 1 represents the hardness obtained by the respective addition of a hardening element Ti, Zr, Al and Y in a proportion of 1% by weight in a metal alloy compared with the hardness of a similar metal alloy without a hardening element.

FIG. 2 is a metallographic section illustrating the effect of adding the hardening element Ti for a selected metal alloy AuAg22Ti1.

FIG. 3 shows the colorimetric measurements for different metal alloys in accordance with the examples illustrating the invention.

FIGS. 4a and 4b respectively illustrate the change in the color and luminosity of different metal alloys in accordance with the illustrative examples of the invention in saline mist exposure aging tests over a period of 1 to 200 days.

FIGS. 5a and 5b show the microstructure of densified samples, respectively from a metal alloy without a hardening element combined with a ceramic reinforcement, and from the same mixture in which the metal alloy comprises a hardening element.

FIG. 6 schematically shows a flowchart for the method for the manufacture of a composite material in accordance with an embodiment of the invention.

In order to simplify the description, the following convention shall be used below for the designation of the alloys: the element content is indicated as a percentage by weight after the symbol for the element. Example: Au75Ag25 corresponds to an alloy comprising 75% gold (18 carats) and 25% silver. In a variation, the “75” could be omitted after the element Au, the percentage by weight of Au then being the complement to 100% of the percentages of the other elements and/or components of the composite material.

The inventive concept resides in using a metal alloy determined in order to obtain a predefined color, which is reinforced with a reinforcement material comprising ceramic particles, in order to form a metal matrix composite material. By this approach, the reinforcement used enables metal alloys with insufficient hardness to become compatible with horological use, which greatly increases the number of metal alloys which can be used, and thus in particular the number of possible colors.

A method for the manufacture of a composite material in accordance with an embodiment of the invention will now be described in detail. In this embodiment, a metal alloy based on gold and silver is used. In particular, the invention is suitable for a metal alloy such that the resulting composite material comprises at least 75% by weight of gold, and comprises between 15% and 24%, or even between 20% and 24% by weight of silver. As will be explained below, the invention therefore makes it possible to use, in a horological application, such a metal alloy which could not be used until now because of its insufficient hardness, as explained above.

More generally, the method that will be described is particularly suitable when a metal alloy is selected that is:
based on gold, comprising at least 75% by weight of gold, or
based on platinum, comprising at least 95% by weight of platinum, or
based on palladium, comprising at least 95% by weight of palladium. It should be noted that the proportions by weight that have been indicated correspond to the percentages by weight in the resulting material, and in particular in the resulting composite material. In the case of an alloy based on gold, the proportion of gold is preferably less than 95% by weight, or even less than 90% by weight, or even less than 80% by weight. Beyond this, the alloy based on gold is very soft and it becomes much more difficult to treat it using the invention, even though this is not excluded. Advantageously, the alloy based on gold is an 18-carat alloy, comprising 75% by weight of gold.

In addition, the method that will be described is also particularly suitable when a metal alloy with a hardness of less than or equal to 70 HV, or even less than or equal to 50 HV, or even less than or equal to 40 HV, is selected.

The first step E1 of the method consists of selecting a metal alloy which will form the basis of the composite material matrix. In the illustrated embodiment, this alloy is based on gold and silver. It should be noted that, because of the invention, it is possible to select this metal alloy from a multitude of possible choices for the metal alloys, including from alloys which are known to be insufficiently hard. Thus, for example, a design expert could select a metal alloy as a function of its color without having to consider its hardness.

In order to manufacture the composite material from this selected metal alloy, the method in accordance with the embodiment of the invention advantageously employs powder metallurgy.

The second step of the method, E2, consists of adding at least one hardening element to the selected metal alloy in order to manufacture a hardened metal alloy.

A hardened metal alloy is therefore prepared by incorporating this hardening element into the selected metal alloy. Advantageously, the composite material comprises between 0.05% and 2% by weight of at least one hardening element, or even between 0.075% and 1.75% of at least one hardening element, or even between 0.1% and 1.5% by weight of at least one hardening element, or even between 0.5% and 1.5% by weight, or even between 0.5% and 1.25% by weight, or even between 0.5% and 1% by weight. It should be noted that these proportions by weight correspond to the percentages by weight in the resulting composite material.

Depending on the embodiment, the at least one hardening element for the metal alloy is selected from elements forming precipitates at low concentrations, in other words having a low solubility in the alloy, in particular from titanium (Ti), zirconium (Zr), aluminum (Al), yttrium (Y), calcium (Ca) or a lanthanide. Thus, one or more of these hardening elements is incorporated into the selected metal alloy in very small proportions in order to form a micro-alloy which we shall term a hardened metal alloy. As an alternative or in addition, the at least one hardening element for the metal alloy is selected from elements that can react with the selected material to reinforce it and/or which can form a reinforcement material in situ during densification, in particular an element selected from boron (B), carbon (C), nitrogen (N) or oxygen (O). It should be noted that the hardening element is therefore an element in the sense of a chemical element, i.e., a simple element and not a compound. On the other hand, this hardening element is integrated into, incorporated into the structure of the alloy itself in order to form a hardened metal alloy. Thus, it is not an element that remains outside the alloy, in contrast to a reinforcement material, as will be described below.

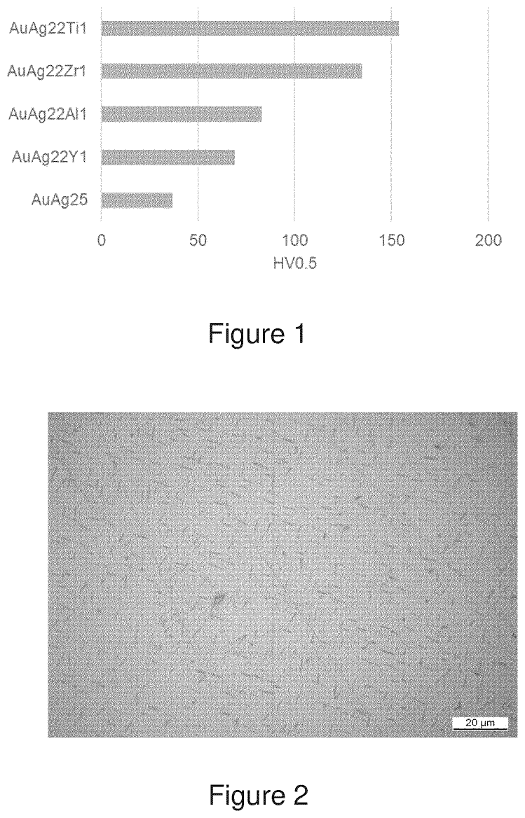

In accordance with the exemplary embodiments of the invention, the hardened metal alloy has a composition AuAg22X1, with X=Ti, Zr, Al or Y. These four hardened metal alloys are manufactured by vacuum fusion. FIG. 1 shows the HV0.5 hardness obtained by adding each of the four hardening elements Ti, Zr, Al and Y compared with the hardness of the metal alloy AuAg25, with no hardening element. It can clearly be seen that each of the hardening elements can very significantly increase the hardness of the metal alloy, up to a factor of almost 4 for Ti. The hardness of the alloy therefore increases up to 135 HV with an addition of 1% by weight of the element Zr and up to 150 HV with an addition of 1% by weight of the element Ti.

It should be noted that, advantageously, the hardening element is added to the selected metal alloy in a very low concentration, close to the solubility limit in the liquid phase. This means that during cooling and passage into the solid phase during the manufacture of the hardened metal alloy, precipitates can be formed in the solid phase which will increase the hardness of the hardened metal alloy. X-ray diffraction measurements show that adding the hardening element Ti causes the formation of intermetallic precipitates which induce hardening of the alloy. FIG. 2 illustrates the effect of adding the hardening element Ti on the microstructure of a bulk specimen of hardened metal alloy, obtained from casting, which highlights the intermetallic precipitates, which are not readily visible on the atomized powder that will be described below, because of the small size of the precipitates.

It should also be noted that the selected hardening elements, in a proportion of 1% by weight in accordance with the exemplary embodiments, may also have an interesting effect on the color and form hardened metal alloys endowed with a satisfactory color stability over time, even when subjected to stresses.

The color is defined in conventional manner by a point in CIELAB space formed by a green-red axis along the abscissa, a blue-yellow axis up the ordinate and an axis representing contrast (cf. the CIE15: 2004 report drawn up by the Commission Internationale de l'Eclairage [International Commission on Illumination]). The measurements were all made using the following convention: D65 illuminant and 10° angle standard observer (CIE1964).

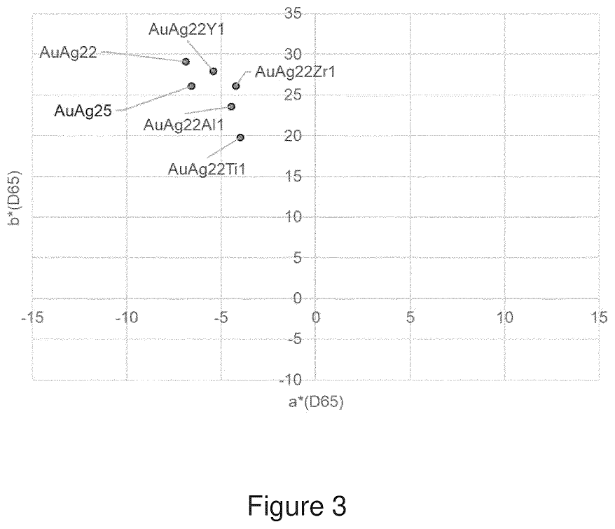

FIG. 3 shows the colorimetric measurements for the different hardened metal alloys in accordance with the exemplary embodiments of the invention, compared with the alloys AuAg22 and AuAg25 without a hardening element. In summary, adding a hardening element on the one hand reinforces the red of the color of an Au—Ag based alloy, with a separation ΔE*ab of +1 to +3, and on the other hand reduces the yellow component to varying extents. For the same percentage by weight, yttrium has the smallest influence on the variation in color, followed by the elements in the order Zr, Al and Ti, with a separation ΔE*ab between 1 and 10. In all cases, the color of a hardened AuAg22X1 type metal alloy remains comparable to that of the base alloy AuAg22 or AuAg25.

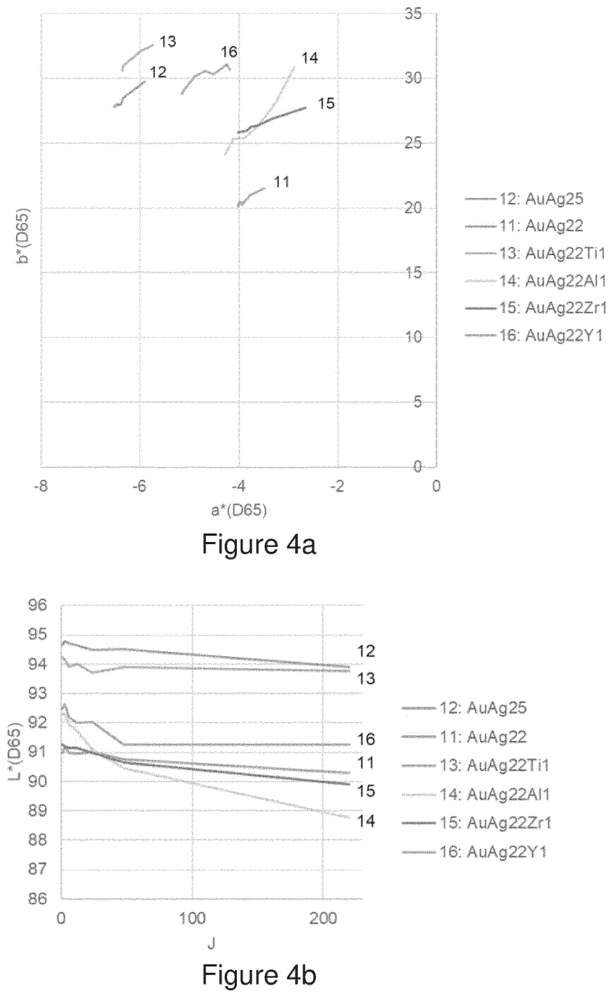

FIGS. 4a and 4b respectively illustrate the change in color (FIG. 4a, a*(D65) plotted against b*(D65)) and luminosity (FIG. 4b, L*(D65) as a function of time) in saline mist exposure aging tests over a period of 1 to 200 days for different alloys based on gold and silver, incorporating or not incorporating the aforementioned hardening elements. In FIGS. 4a and 4b, the curves 13 illustrate the behavior of the metal alloy hardened with the hardening element Ti. They show that this behavior is similar to that of a base metal alloy without a hardening element Ti, in particular the metal alloy AuAg22 illustrated by the curves 11 and the metal alloy AuAg25 illustrated by the curves 12. The curves 14 to 16 illustrate the behavior of the hardened metal alloy with the respective hardening elements Al, Zr and Y.

The method then carries out a third step E3 for the preparation of a powdered composite material.

To this end, the method in accordance with the embodiment comprises a first sub-step E31 for producing a hardened metal alloy powder. Any milling or atomization process may be implemented for this step E31 for producing a hardened metal alloy powder. Preferably, this sub-step E31 is carried out by atomization, more particularly by gas atomization or ultrasonic atomization. Advantageously, this step E31 for producing the metal powder is such that the resulting metal powder has particles with a mean dimension of less than or equal to 200 μm, or even less than or equal to 100 μm, or even less than or equal to 50 μm.

The method then implements a second sub-step E32 for mixing of the metal powder obtained previously with a reinforcing powder comprising ceramic particles. The function of the reinforcing powder is to reinforce the selected metal alloy the hardness of which, and more generally the mechanical properties of which, might be insufficient for the desired horological application.

The ceramic particles may be produced from aluminum oxide (Al₂O₃), zirconium oxide (ZrO₂), titanium oxide (TiO₂), titanium nitride (TiN), silicon oxide (in particular SiO or SiO₂), silicon carbide (SiC), diamond, boron nitride (BN), boron carbide (B₄C), silicon nitride (Si₃N₄), or aluminum titanate (Al₂TiO₅). A single or several ceramics from the above list may be used. In a variation, any other ceramic may be used.

The reinforcing powder may thus comprise ceramic particles in a single material, or a mixture of ceramic particles of two, three or more different materials. In addition, the reinforcing powder may be entirely constituted by ceramic particles. In a variation, it may be based on a ceramic, i.e. comprise at least 50% by weight of ceramic, and comprise reinforcing particles of other natures.

By the term “ceramic” we mean a technical ceramic, which is distinguished from a traditional ceramic in its composition because it is obtained from a purified synthetic powder and not from a natural mineral powder such as feldspar or kaolin, for example. In general, technical ceramic materials have a certain number of properties which make them suitable for a range of different applications. More particularly, these properties are the hardness, physical stability, an extreme resistance to heat and chemical inertia, inter alia. Suitable technical ceramic materials are materials such as alumina, aluminum nitride, aluminum silicate; zirconium silicate, boron carbide, boron nitride; zirconium, titanium, hafnium, niobium and/or silicon nitrides, carbides and carbonitrides; barium titanate, magnesium, titanium and zirconium oxide (zirconia). In the context of the present invention, alumina and/or zirconia is/are preferable.

Advantageously, the proportion of the reinforcing powder corresponds to a proportion by weight comprised between 0.5% and 10%, or even comprised between 1% and 5% of the total composition of composite material by weight. This proportion is selected to be sufficiently high to obtain a suitable hardness for the composite material, but sufficiently low to prevent modification to the base color of the selected metal alloy.

On the other hand, advantageously, the ceramic particles of the reinforcing powder have a mean dimension of less than or equal to 1 μm, or even less than or equal to 0.5 μm, or even less than or equal to 0.2 μm, or even less than or equal to 0.1 μm. The small particle size means that on the one hand they are not visible, and on the other hand the number of reinforcing particles can be maximized for a given proportion by weight.

Another important factor is the distribution of the reinforcing particles in the composite material. It is in fact advantageous for the reinforcing particles to be dispersed in the metal matrix of the final composite material in a homogeneous or substantially homogeneous manner, and not to form a continuous network between them. This homogeneous dispersion is favored by milling the hardened metal alloy, as will be described below.

According to the advantageous embodiment of the invention, simple mixing of the two powders is supplemented by milling. The composite powder may, for example, be obtained by milling on a standard planetary ball mill type mill. The milling speed is advantageously comprised between 200 and 800 rpm, or even in a range from 100 to 1200 rpm. In addition, the milling time is selected to be between 3 h and 12 h. The milling time may vary between 1 h and 48 h, depending on the metal alloy and the milling speed. The aim of supplementing mixing of the two powders by milling is to incorporate the reinforcing particles (sub-micrometric in size) into the particles of the powdered metal alloy. In this case, the reinforcing particles are located inside the metal grains after sintering, and act as obstacles to the movement of the dislocations, resulting in optimized hardening. In addition, in order to encourage this result, it is advantageous to obtain a homogeneous distribution of the reinforcing particles in the metal matrix of the composite material. For this, suitable milling is optimal, in which the particles of the metal powder are deformed, work hardened and break apart under the action of the balls of the mill in order for them to re-agglomerate and be incorporated into the reinforcing particles. A metal alloy which is too soft does not work harden sufficiently to break apart, which would render the method less efficient and would result in a heterogeneous mixture. Thus, the at least one hardening element here acts to increase the hardness of the metal alloy, which has the additional advantage of rendering it suitable for optimal milling, enabling a homogeneous distribution of the reinforcing particles to be obtained. It should be noted that the at least one hardening element for the metal alloy is thus essentially involved in this intermediate milling phase of the method, in order to encourage optimal mixing of the reinforcing particles with the metal alloy and therefore to optimize the respective positioning of the metal alloy and the reinforcing particles in the final composite material. For the majority of envisaged applications, the at least one hardening element cannot be used to form a hardened metal alloy which has sufficient properties that would allow the use of the aforementioned reinforcing particles to be dispensed with. In particular, without the steps for producing the metal powder and for adding the reinforcer, the at least one hardening element would form precipitates at the grain boundaries during solidification, resulting in a coarse and heterogeneous microstructure which would not be suitable for the production of a properly finished surface, in particular by polishing.

In accordance with a variational embodiment, the step for the preparation of the metal powder or for mixing said metal powder with a reinforcing powder comprises adding oxygen, boron, carbon and/or nitrogen, in a pure form or in the form of the oxide, boride, nitride or carbide, in a proportion by weight of less than or equal to 2% and preferably greater than or equal to 0.05%. This variational embodiment has the effect of encouraging the formation of precipitates in situ, during the last step for densification and/or during a heat treatment and/or potentially during milling, which act as reinforcing particles in the final composite material. More precisely, the reinforcing powder added at E32 may act as a precursor to the final reinforcing particles present in the composite material, which will be formed during the last step for densification and/or during a heat treatment. As an example, boron and/or carbon and/or nitrogen and/or oxygen added as a component of the reinforcing powder could react with Ti, or Zr, or Al or Y, or Nb, or Hf, or V, or Ta, or Cr, or M, or W present in the alloy in the form of a solid solution, in order to form the reinforcing particles during the last step for densification and/or during a subsequent heat treatment.

It should be noted that the reinforcement material is therefore in the form of particles which are distributed in the composite material inside the metal matrix formed by the hardened metal alloy. In contrast to the hardening element, which is positioned in the structure of the metal alloy itself, the reinforcement material acts in the form of particles positioned outside the metal alloy per se, in a juxtaposed manner to the hardened metal alloy, in order to form a monolithic composite material in which the particles of reinforcement material are interlaced with the assembly formed by the hardened metal alloy which forms a metal matrix of the composite material. The particles of reinforcement material therefore strengthen the hardened metal alloy, compared with a hardened metal alloy which would be used alone without a reinforcement material.

The method then carries out a fourth step E4 for densification of the composite material powder obtained in the preceding step. According to this embodiment, this densification is carried out by sintering, carried out using a Spark Plasma Sintering (SPS) type technique which is also known as flash sintering. The mixed and compacted powders are placed in a crucible, for example a cylindrical crucible, and are heated by the Joule effect by placing the crucible between two electrodes and passing a direct current, which may or may not be pulsed, with an intensity that is typically a few kA. The method is carried out in an inert or reactive atmosphere, or under vacuum, as well as under pressure, typically of the order of a few MPa.

The advantage with heating using the Joule effect is that the heating and cooling rates are very high, thereby enabling the total duration of the heat treatment to be reduced and the growth of grains of metal alloy and any precipitates to be limited. The microstructure obtained will largely reflect that of the base powders, hence the value in using powders with grains having small dimensions. The mechanical properties that are suitable for horological applications, in particular hardness, are promoted by a fine microstructure in the composite material.

In the exemplary embodiments, the heating and cooling rate is at least 1 K/min, preferably more than 50 K/min, typically 100 K/min, with a favorable window between 50 and 200 K/min. The sintering temperature is advantageously between 800° C. and 900° C., or more broadly between 600° C. and 1000° C. These values would potentially have to be adapted to the type and to the size of the powder. The treatments are carried out under vacuum, or in an inert gas such as Ar or Formiergaz (a mixture of N₂ and H₂). It should be noted that the fusion temperature of the reinforcement material is advantageously higher than the sintering temperature used.

In a variation, other densification methods may also be envisaged, such as hot pressing, Hot Isostatic Pressing (HIP), conventional sintering or sintering with a pulsed electric current or Electro Sinter Forging (ESF). Optionally, the densification step may comprise an additional heat treatment, under vacuum or in a neutral atmosphere or in a reactive atmosphere.

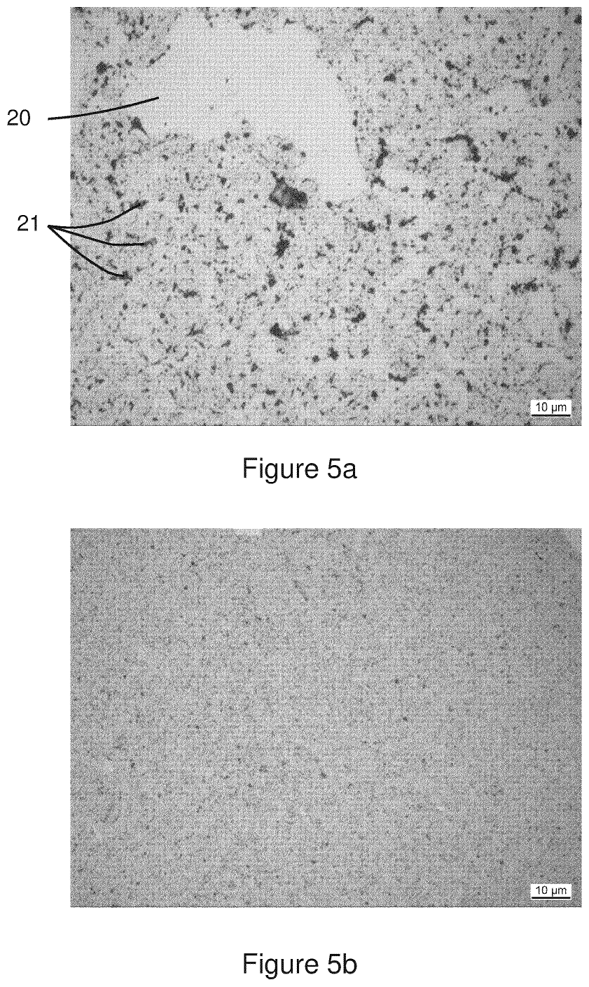

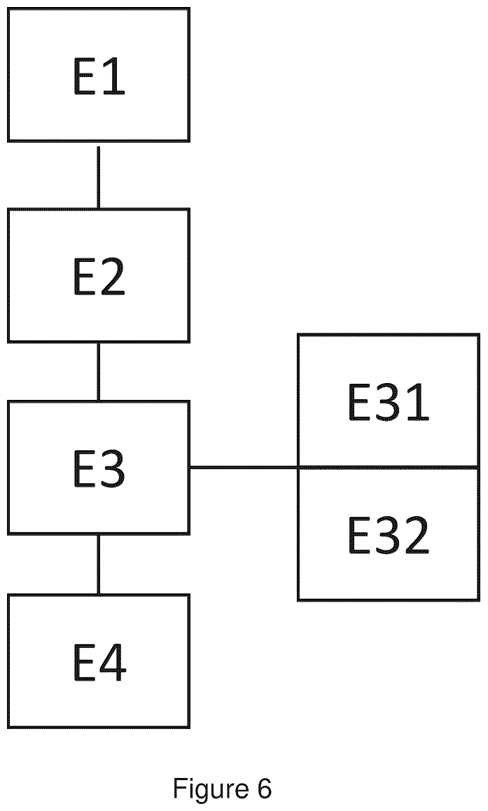

FIGS. 5a and 5b show the microstructure of specimens sintered in accordance with the method described above, respectively from an Au—Ag metal alloy combined with an Al₂O₃ ceramic reinforcement, without a hardening element, resulting in an AuAg₂₂-Al₂O₃ 2% composite material and on the other hand with the same Au—Ag metal alloy but comprising the hardening element Ti, in accordance with the exemplary embodiment of the invention mentioned above, combined with an Al₂O₃ ceramic reinforcement. It can be seen from FIG. 5b that the composite material of the invention comprises a metal matrix forming a continuous network, including a substantially homogeneous and/or discontinuous distribution of reinforcement material based on ceramic in the matrix. It should be noted that because the size of the ceramic particles is very small, they are not directly visible to the naked eye and are therefore difficult to detect on the metallographic section of FIG. 5b. The hardness measured for the AuAg22Ti1-Al₂O₃ 2% composite material of FIG. 5b is 202 HV0.5. In contrast, the composite material of FIG. 5a comprises clear zones 20 that correspond to pieces of poorly milled metal alloy, which remain present because of the low hardness of the Au—Ag metal alloy. The black spots 21 correspond to agglomerates of alumina. The structure of this composite material is therefore very different to that of the composite material of the invention, and far less optimized. The measured hardness of the AuAg22-Al₂O₃ 2% composite material of FIG. 5a is substantially lower, only 91 HV0.5. These figures therefore provide a good illustration of the effect of adding the hardening element to the metal alloy. As explained above, this hardening element can therefore be used to mill the metal alloy better and can be used to obtain a composite material without an unmilled zone and with no agglomerate. The reinforcing particles are therefore distributed homogeneously in the powder, then in the final composite material.

The embodiment of the invention has been described for a manufacturing method based on a powder metallurgy technique, in particular with a densification by sintering. In accordance with a variational embodiment, the hardened metal alloy powder or the composite material powder could be modified to adapt it to densification by an additive laser manufacturing technique or, for example, it could be modified by adding a binder for deposition using a “binder jetting” type printer.

It should be noted that the method in accordance with the invention can be used to form a highly advantageous composite material which comprises a structure provided with mechanical properties that are ideally suited to the desired horological applications, and which match the desired objectives well. It should be noted that the method in accordance with the invention can therefore be used to define a composite material the structure of which is substantially improved with respect to a metallic material that was simply reinforced by infiltration of reinforcing elements, or with respect to a ceramic material with a continuous ceramic phase which would be infiltrated by a metal material. In particular, the method in accordance with the invention can be used to define a composite material with a continuous metallic network, enabling a substantially improved mechanical strength and toughness to be obtained.

The invention also pertains to a metal matrix composite material for a horological component per se. In accordance with this embodiment, a composite material of this type is constituted by:
a metal alloy
based on gold, the composite material comprising at least 75% by weight of gold, or
based on platinum, the composite material comprising at least 95% by weight of platinum, or
based on palladium, the composite material comprising at least 95% by weight of palladium,
the composite material further comprising between 0.1% and 2% by weight of at least one hardening element for the metal alloy, or even between 0.5% and 2% by weight, or even between 0.5% and 1.5% by weight, or even between 0.5% and 1.25% by weight, or even between 0.5% and 1% by weight of at least one hardening element for the metal alloy; and
a reinforcement material, in a proportion by weight comprised between 0.5% and 10%, or even comprised between 1% and 5%, comprising ceramic particles.

It appears that the bond between the reinforcement material and the metal alloy is improved by the presence of the hardening element in the metal alloy.

Advantageously, the metal alloy selected in the embodiment of the invention does not comprise copper and/or iron or comprises less than 0.5% of copper and/or iron.

In a variation, the composite material comprises at least 75% by weight of gold, and less than 99.9% by weight of gold, or even less than 99% by weight of gold, or even less than 95% by weight of gold, or even preferably less than 90% by weight of gold, or even less than 80% by weight of gold.

The metal matrix composite material advantageously comprises a structure in which a hardened metal alloy forms a continuous network, thereby forming a metal matrix of the composite material. In addition, the ceramic particles of the reinforcement material are advantageously distributed substantially homogeneously and/or discontinuously in the composite material.

The invention can be employed to manufacture a metal matrix composite material that has a hardness which is greater than or equal to 135 HV, or even greater than or equal to 150 HV, or even greater than or equal to 200 HV.

The low reinforcement material content has little influence on the color of the composite material, i.e., the color of the composite material is close to that of the initially selected metal alloy, which can therefore in particular be selected for its color, as a function of the desired esthetic effect.

The invention also pertains to a horological component, characterized in that it comprises a composite material as described above. In fact, this composite material performs particularly well as regards producing all or part of a horological component, in particular a component of the external part of a watch, such as a wristwatch casing or eyeglasses, or a bracelet element or a bracelet clasp element. It may also be used to manufacture a component of a piece of jewelry or fine jewelry.

Naturally, the production of a horological component, a piece of jewelry or of fine jewelry, means manufacturing all or a significant portion of the thickness of such a horological component, and not a simple surface coating. Thus, the components under consideration comprise a large quantity of composite material, advantageously in the form of a solid component, in particular comprising at least one part with a thickness of 0.1 mm or more. Naturally, there is nothing to prevent adding a coating to all or part of the composite material under consideration, even though it is not the preferred embodiment.

The invention also pertains to a horological item, characterized in that it comprises at least one horological component as described above.

1. A metal matrix composite material for a horological component, wherein the composite material comprises:
a metal alloy
based on gold, the composite material comprising at least 75% by weight of gold, or
based on platinum, the composite material comprising at least 95% by weight of platinum, or
based on palladium, the composite material comprising at least 95% by weight of palladium,
at least one hardening element, the composite material comprising from 0.1% to 2% by weight of the at least one hardening element; and
a reinforcement material, the composite material comprising from 1% to 10% by weight of the reinforcement material, wherein the reinforcement comprises ceramic particles.

2. The metal matrix composite material as claimed in claim 1, wherein the metal matrix of the composite material consists of the metal alloy hardened by the at least one hardening element.

3. The metal matrix composite material as claimed in claim 1, wherein the ceramic particles have a mean dimension of less than or equal to 1 μm.

4. The metal matrix composite material as claimed in claim 1, wherein the ceramic particles are oxides and/or carbides and/or nitrides and/or borides.

5. The metal matrix composite material as claimed in claim 1, wherein the at least one hardening element for the metal alloy is selected from the group consisting of titanium (Ti), zirconium (Zr), aluminum (Al), yttrium (Y), calcium (Ca), and lanthanides.

6. The metal matrix composite material as claimed in claim 1, wherein the metal alloy is an alloy based on gold comprising silver, the composite material comprising from 15% to 24% by weight of silver.

7. The metal matrix composite material as claimed in claim 1, wherein the metal alloy without the at least one hardening element has a hardness of less than or equal to 70 HV.

8. The metal matrix composite material as claimed in claim 1, wherein
the metal alloy forms a continuous network of the metal matrix of the composite material, and/or
the ceramic particles of the reinforcement material are distributed substantially homogeneously and/or discontinuously in the composite material.

9. The metal matrix composite material as claimed in claim 1, wherein the composite material has a hardness of greater than or equal to 135 HV.

10. A horological comprising the composite material as claimed in 1.

11. The horological component as claimed in claim 10, which is a component of an external part of a watch or eyeglasses or a bracelet element or a bracelet clasp element.

12. A horological item comprising the horological component as claimed in claim 10.

13. A method of manufacturing a metal matrix composite material for a horological component, wherein the method comprises:
preparing a metal alloy
based on gold, so that the composite material comprises at least 75% by weight of gold, or
based on platinum, so that the composite material comprises at least 95% by weight of platinum, or
based on palladium, so that the composite material comprises at least 95% by weight of palladium,
the metal alloy further comprising a hardening element, so that the composite material comprises from 0.1% to 2% by weight of the at least one hardening element;
producing a metal powder from the metal alloy;
mixing the metal powder with a reinforcing powder comprising ceramic particles, so that the composite material comprises from 1% to 10% of the reinforcing powder, to obtain a powdered composite material; and
densifying the powdered composite material.

14. The method claimed in claim 13, wherein the ceramic particles of the reinforcing powder have a mean dimension of less than or equal to 1 μm.

15. The method as claimed in claim 13, wherein the metal powder has particles with a mean dimension of less than or equal to 200 μm.

16. The method as claimed in claim 13, wherein the densifying comprises a rapid sintering, using Spark Plasma Sintering (SPS), hot pressing, Hot Isostatic Pressing (HIP), conventional sintering, pulsed electric current sintering, microwave sintering, electro sinter forging, and/or material addition.

17. A method as claimed in claim 13, wherein the producing of the metal powder and/or the mixing of the metal powder with a reinforcing powder comprises an addition of oxygen, carbon and/or nitrogen and/or boron, in a pure form and/or in oxide, nitride, boride or carbide form, in a proportion by weight of less than or equal to 2%.

18. The metal matrix composite material as claimed in claim 1, wherein the metal alloy is based on gold, the composite material comprising from 75% to 95% by weight of gold, from 0.5% to 1.5% by weight of the at least one hardening element, and from 1% to 5% by weight of the reinforcement material.

19. The metal matrix composite material as claimed in claim 1, wherein the ceramic particles are selected from the group consisting of aluminum oxide (Al₂O₃), zirconium oxide (ZrO₂), titanium oxide (TiO₂), silicon oxides, silicon carbide (SiC), titanium carbide (TiC), diamond, boron nitride (BN), boron carbide (B₄C), silicon nitride (Si₃N₄), and/or aluminum titanate (Al₂TiOₛ), and titanium nitride (TiN).

20. The metal matrix composite material as claimed in claim 1, wherein the ceramic particles are in a technical ceramic.
